(19) United States
(12) Patent Application Publication
(10) Pub. No.: US 2007/0209194 A1
(43) Pub. Date: Sep. 13, 2007

(54) System and method for the manufacture of coil windings

(75) Inventor: Michael Bradfield, Anderson, IN (US)

Correspondence Address: ICE MILLER LLP, ONE AMERICAN SQUARE, SUITE 3100, INDIANAPOLIS, IN, 46282-0200, US

(73) Assignee: Remy International, Inc., a Delaware corporation, Anderson, IN (US)

(21) Appl. No.: 11/356,336

(22) Filed: Feb. 16, 2006

(51) Int. Cl. H01F 7/06

(52) U.S. Cl. 29/605; 29/606; 29/729; 336/221

(57) ABSTRACT

A method of manufacturing an electrical coil. An embodiment of the method comprises providing a core, the core being constructed of a material suitable for use in an electrical coil, the core being of a generally cylindrical shape; providing wire, the wire being of a type suitable for use in an electrical coil, the wire comprising an electrical conductor surrounded by insulation, the electrical conductor having a substantially circular cross-section; winding the wire around an outer surface of the core; and while the wire is winding, compressing the wire thereby causing the cross-section of the electrical conductor to permanently change shape. In an aspect of an embodiment of the present invention, the step of compressing the wire comprises the steps of positioning the wire between the core and at least one cylindrical roller; and apply force against the wire with the at least one cylindrical roller.

### BACKGROUND

The use of wound electrical coils is widespread. Wound electrical coils typically comprise round magnet wire of a predetermined gauge that is wrapped or coiled around an core. In a typical application, multiple layers of insulated magnet wire are wound around the core.

Because of magnet wire's round cross-sectional shape, the “fill factor” using magnet wire is significantly less than 100%. In other words, even when laid as closely as possible, consistent with typical coil-winding practices, the round magnet wire does not effectively fill all the available space in the winding area of a wound electrical coil. For many applications, the fill factor using round magnet wire is sufficient. However, in applications where space is a premium or where winding density is critical to the competitiveness of the electrical coil design, the use of round wire is a limiting factor. In many such cases, square or rectangular magnet wire is used. The use of square or rectangular magnet wire increases the fill factor and decreases the volume of space occupied by the winding, but presents several disadvantages. First, square or rectangular magnet wire is significantly more expensive than round magnet wire. Second, the coil winding process is made significantly more difficult by the use of square or rectangular magnet wire. Square or rectangular magnet wire must be precisely oriented during the winding process to ensure that it lays flat, square, and true. Special tooling and processes must be used to reel and de-reel the square or rectangular magnet wire and to wind the square or rectangular magnet wire on a given coil.

For the foregoing reasons, it is desire to provide a method for increasing the fill factor of a wound electrical coil, without requiring the use of non-round magnet wire.

### SUMMARY

In an embodiment, the present invention comprises a method of manufacturing an electrical coil. An embodiment of the method comprises the steps of providing a core, the core being constructed of a material suitable for use in an electrical coil, the core being of a generally cylindrical shape; providing wire, the wire being of a type suitable for use in an electrical coil, the wire comprising an electrical conductor surrounded by insulation, the electrical conductor having a substantially circular cross-section; winding the wire around an outer surface of the core; and while the wire is winding, compressing the wire thereby causing the cross-section of the electrical conductor to permanently change shape. In an aspect of an embodiment of the present invention, the step of compressing the wire comprises the steps of positioning the wire between the core and at least one cylindrical roller; and apply force against the wire with the at least one cylindrical roller. In an aspect of an embodiment of the present invention, the force is sufficient to permanently change the shape of the cross-section of the electrical conductor, but is insufficient to breach the insulation of the wire.

In an embodiment, the present invention comprises a system for manufacturing an electrical coil. An embodiment of the system comprises a first roller, the first roller being of a generally cylindrical shape and having a longitudinal axis and an outer surface. The first roller is capable of rotating about its longitudinal axis. The longitudinal axis of the first roller is parallel with the longitudinal axis of the core. The outer surface of the first roller is capable of exerting a first force against the wire such that the wire is compressed between the first roller and the core, thereby causing the cross-section of the electrical conductor to permanently change shape. In an aspect of an embodiment of the present invention, the system further comprises a second roller. The second roller has a generally cylindrical shape and a longitudinal axis and an outer surface. The second roller is capable of rotating about its longitudinal axis. The longitudinal axis of the second roller is parallel with the longitudinal axis of the core. The outer surface of the second roller is capable of exerting a second force against the wire such that the wire is compressed between the second roller and the core, thereby causing the cross-section of the electrical conductor to permanently change shape. In an aspect of an embodiment of the present invention, the first roller, the second roller, and the core are arranged such that the first roller and the second roller are diametrically opposed about the core.

In an embodiment, the present invention comprises a wound electrical coil. An embodiment of the wound electrical coil comprises a generally cylindrical shaped core having an outer surface, the core being constructed of a material suitable for use in an electrical coil; and wire wound around the outer surface of the core, the wire comprising an electrical conductor surrounded by insulation, the cross section of the electrical conductor having a flattened circular shape.

### BRIEF DESCRIPTION OF THE DRAWINGS

The features and advantages of this invention, and the manner of attaining them, will be more apparent and better understood by reference to the following descriptions of embodiments of the invention, taken in conjunction with the accompanying drawings, wherein:

FIG. 1 shows a system implementing an embodiment of the present invention; and

FIG. 2 shows a partial cross-sectional view of a wound electrical coil, taken along line II-II of FIG. 1.

### DESCRIPTION

For the purposes of promoting an understanding of the principles of the present inventions, reference will now be made to the embodiments illustrated in the drawings, and specific language will be used to describe the same. It will nevertheless be understood that no limitation of the scope of these inventions is thereby intended.

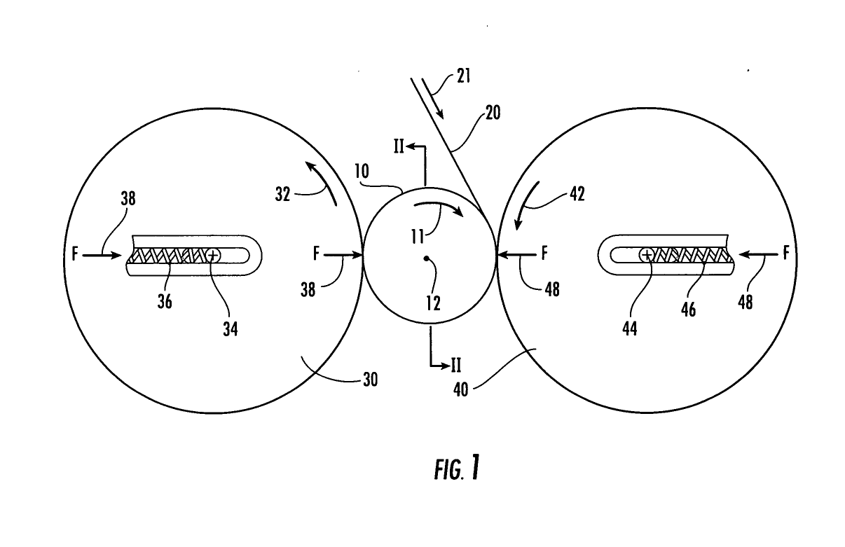

FIG. 1 shows a system implementing an embodiment of the present invention. Show in FIG. 1 is an end view of core 10. Core 10 is a cylindrically shaped core suitable for a wound electrical coil. As core 10 is rotated around its longitudinal axis 12 in rotational direction 11, magnet wire 20 is fed from a reel or other source (not shown) in direction 21. The rotation of core 10 causes magnet wire 20 to be wound around the outer surface of core 10.

Rollers 30 and 40 are also shown in FIG. 1. Roller 30 is a cylindrically shaped roller comprising longitudinal axis 34. Roller 30 comprises a spring biasing mechanism 36. A portion of roller 30 is cutaway in FIG. 1 to reveal spring biasing mechanism 36. Roller 40 is a cylindrically shaped roller comprising longitudinal axis 44. Roller 40 comprises a spring biasing mechanism 46. A portion of roller 40 is cutaway in FIG. 1 to reveal spring biasing mechanism 46.

As magnet wire 20 is wound around core 10, magnet wire 20 passes between roller 30 and core 10, and also between roller 40 and core 10. Spring biasing mechanism 36 forces roller 30 against magnet wire 20. The direction of the force exerted by roller 30 is shown by arrows 38. Spring biasing mechanism 46 forces roller 40 against magnet wire 20. The direction of the force exerted by roller 40 is shown by arrows 48.

Because the conductor in magnet wire 20 is softer than the materials from which core 10, roller 30, and roller 40 are constructed, the force exerted by rollers 30 and 40 causes a slight flattening of magnet wire 20. Rollers 30 and 40 are constructed of steel or other material having a suitable hardness.

The force exerted by rollers 30 and 40 during the winding process must be sufficient to slightly flatten magnet wire 20, but cannot be such that the insulation of magnet wire 20 is breached or that the conductor of magnet wire 20 is broken. In an embodiment, a force of between about 100 pounds and about 200 pounds is exerted by rolling drums 30 and 40.

In an embodiment, each layer of magnet wore 20 is flattened by about 0.004″-0.008″. Accordingly, in an embodiment comprising twelve 12 layers of magnet wire around the core, the radial dimension of the wound coil can be reduced by about 0.048″-0.096″ while maintaining electrical and magnetic characteristics.

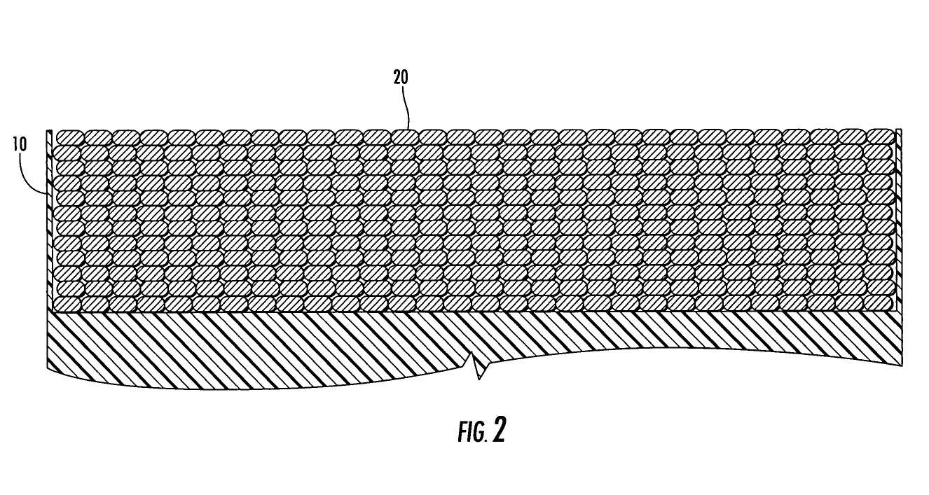

FIG. 2 shows a partial cross-sectional view of a wound electrical coil, taken along line II-II of FIG. 1. Shown in FIG. 2 are core 10, and several layers of magnet wire 20. As shown in FIG. 2, magnet wire 20 has been slightly flattened by the pressure exerted by rollers 30 and 40 during the coil winding process.

While this invention has been described as having a preferred design, the present invention can be further modified within the scope and spirit of this disclosure. This application is therefore intended to cover any variations, uses, or adaptations of the invention using its general principles. Each such implementation falls within the scope of the present invention as disclosed herein and in the appended claims. Furthermore, this application is intended to cover such departures from the present disclosure as come within known or customary practice in the art to which this invention pertains and which fall within the limits of the appended claims.

I claim:

1. A method of manufacturing an electrical coil, the method comprising the steps of:
providing a core, said core being constructed of a material suitable for use in an electrical coil, said core being of a generally cylindrical shape;
providing wire, said wire being of a type suitable for use in an electrical coil, said wire comprising an electrical conductor surrounded by insulation, said electrical conductor having a substantially circular cross-section;
winding said wire around an outer surface of said core; and
while said wire is winding, compressing said wire thereby causing said cross-section of said electrical conductor to permanently change shape.

2. The method of claim 1, wherein the step of compressing said wire comprises the steps of:
positioning said wire between said core and at least one cylindrical roller; and
apply force against said wire with said at least one cylindrical roller.

3. The method of claim 2, wherein said force is sufficient to permanently change the shape of said cross-section of said electrical conductor, but is insufficient to breach said insulation of said wire.

4. The method of claim 2, wherein said force is at least about 100 pounds.

5. The method of claim 2, wherein said force is less than about 200 pounds.

6. A system for manufacturing an electrical coil, the electrical coil being of the type comprising a generally cylindrical shaped core having a longitudinal axis and an outer surface and being constructed of a material suitable for use in an electrical coil, and wire of a type suitable for use in an electrical coil comprising an insulated electrical conductor having substantially circular cross-section, the wire being wound around the core as the core rotates around its longitudinal axis, the system comprising:
a first roller, said first roller being of a generally cylindrical shape and having a longitudinal axis and an outer surface, said first roller capable of rotating about its longitudinal axis, said longitudinal axis of said first roller being parallel with said longitudinal axis of said core, said outer surface of said first roller capable of exerting a first force against said wire such that said wire is compressed between said first roller and said core, thereby causing said cross-section of said electrical conductor to permanently change shape.

7. The system of claim 6, wherein said first force is sufficient to permanently change the shape of said cross-section of said electrical conductor, but is insufficient to breach said insulation of said wire.

8. The system of claim 6, wherein said first force is at least about 100 pounds.

9. The system of claim 6, wherein said first force is less than about 200 pounds.

10. The system of claim 6, further comprising:
a second roller, said second roller being of a generally cylindrical shape and having a longitudinal axis and an outer surface, said second roller capable of rotating about its longitudinal axis, said longitudinal axis of said second roller being parallel with said longitudinal axis of said core, said outer surface of said second roller capable of exerting a second force against said wire such that said wire is compressed between said second roller and said core, thereby causing said cross-section of said electrical conductor to permanently change shape.

11. The system of claim 10, wherein said second force is sufficient to permanently change the shape of said cross-section of said electrical conductor, but is insufficient to breach said insulation of said wire.

12. The system of claim 10, wherein the combination of said first force and said second force is at least about 100 pounds.

13. The system of claim 10, wherein the combination of said first force and said second force is less than about 200 pounds.

14. The system of claim 10, wherein said first roller, said second roller, and said core are arranged such that said first roller and said second roller are diametrically opposed about said core.

15. A wound electrical coil, said wound electrical coil comprising:
a generally cylindrical shaped core having an outer surface, said core being constructed of a material suitable for use in an electrical coil; and
wire wound around said outer surface of said core, said wire comprising an electrical conductor surrounded by insulation, the cross section of said electrical conductor having a flattened circular shape.
